(19) United States
(12) Patent Application Publication
(10) Pub. No.: US 2025/0196390 A1
(43) Pub. Date: Jun. 19, 2025

(54) Miter Gauge for a Table Saw

(71) Applicant: Robert Bosch GmbH, Stuttgart (DE)

(72) Inventor: Andrew Frolov, Glenview, IL (US)

(21) Appl. No.: 18/538,842

(22) Filed: Dec. 13, 2023

(51) Int. Cl. B27B 25/10

(52) U.S. Cl. CPC B27B 25/10

(57) ABSTRACT

A miter gauge includes a miter housing and a miter bar. The miter bar includes a first portion to which the miter housing is attached and that has a fixed first width and a second portion having a width adjustment system configured to adjust a second width of the second portion. The second portion includes a first prong and a second prong separated longitudinally from one another by a longitudinal slot.

### FIELD

This application relates to the field of miter gauges for table saws and, particularly to adjustable miter gauges for table saws.

### BACKGROUND

In materials processes, for example making a cut in wood or a similar material, it is important to be able to precisely control the relative movement of the workpiece and the saw blade to ensure that the resulting cut is formed with the desired dimensions. However, precisely controlling the relative movement of the workpiece and the saw blade can be challenging when making, for example, irregularly shaped, curved, and angled cuts. Thus, guiding surfaces have been developed which can be firmly yet movably attached to cutting devices to provide a stable surface to guide the relative movement of the workpiece and the saw blade during the cutting process.

In particular, miter gauges have been developed to guide workpieces when angled cuts are made with a table saw. As shown in FIG. 1, a table saw 10 includes a saw blade 12 and a table top 14 having a slot 18 formed in a work surface 20 and the table top 14. The table saw 10 also includes a miter gauge 22, which includes a miter housing 26 and a miter bar 30. The miter bar 30 is slidingly received in the slot 18 to slidably couple the miter gauge 22 to the table top 14. When the table saw 10 is used to perform a cutting operation that does not require the miter gauge 22, the miter gauge 22 can be removed from the table top 14 by sliding the miter bar 30 completely out of the slot 18. The miter housing 26 is rotatably coupled to the miter bar 30 and has a planar miter surface 34, which provides a stable guiding surface to the workpiece. Thus, because the miter bar 30 is rotationally fixed relative to the work surface 20 by the slot 18, rotationally adjusting the miter housing 26 on the miter bar 30 sets an angle of the miter surface 34, and thus of the workpiece supported by the miter surface 34, relative to the saw blade 12.

As shown in FIG. 2, the slot 18 formed in the work surface 20 and the table top 14 has a T-shape, including a main opening 38 and an engagement opening 42. The main opening 38 includes a first wall 46 and a second wall 50, which are formed opposite and facing toward one another. The first and second walls 46, 50 are spaced apart from one another by a first distance D1. The first and second walls 46, 50 are formed perpendicularly to the work surface 20, such that, as shown in FIG. 2, they are vertical. The engagement opening 42 is formed within the main opening 38 and includes a third wall 54 and a fourth wall 58, which are opposite and facing toward one another. The third and fourth walls 54, 58 are parallel to the first and second walls 46, 50 such that the third and fourth walls 54, 58 are also vertical. The third and fourth walls 54, 58 are spaced apart from one another by a second distance D2, which is larger than the first distance D1. Thus, the engagement opening 42 is formed as a wider cut-out in the main opening 38. The slot 18 further includes a fifth wall 62, which is formed between the first wall 46 and the third wall 54, and a sixth wall 66, which is formed between the second wall 50 and the fourth wall 58. The fifth and sixth walls 62, 66 are perpendicular to the first, second, third, and fourth walls 46, 50, 54, 58 such that the fifth and sixth walls 62, 66 are horizontal.

As shown in FIG. 3, the miter bar 30 is generally matingly shaped to slide within the slot 18. The miter bar 30 includes a main portion 70, configured to slide between the first and second walls 46, 50, and an engagement portion 74, configured to slide between the third and fourth walls 54, 58. Accordingly, the main portion 70 has a first width W1, which is smaller than the distance D1 (shown in FIG. 2), and the engagement portion 74 has a second width W2, which is larger than the first distance D1 and smaller than the second distance D2 (shown in FIG. 2). Thus, the engagement portion 74 of the miter bar 30 engages within the engagement opening 42 of the slot 18 and prevents the miter bar 30 from being lifted out of the slot 18 in a direction perpendicular to the work surface 20.

Often, miter gauges 22 are a separate accessory to the table saw 10 and are configured to be repeatedly insertable and removable, as needed, from the table saw 10. Accordingly, the relative dimensions of the miter bar 30 and the slot 18 must be sized so as to allow the miter gauge to slide smoothly. Furthermore, the slots 18 formed in different table saws 10 may not have the same first and second distances D1, D2. Accordingly, the main portion 70 and the engagement portion 74 must be sized so as to fit within slots 18 having some dimensional variation. Finally, each of the slot 18 and the miter bar 30 will be produced having dimensions within manufacturing tolerances. Accordingly, each slot 18 and each miter bar 30 will have unique dimensions, and the slot 18 and the miter bar 30 must be sized to accommodate the manufacturing tolerances of the matingly formed part.

As shown in FIG. 3, due to the aforementioned size requirements and variations of the slot 18 and miter bar 30, gaps 78 may be present between the main portion 70 of the miter bar 30 and the main opening 38 of the slot 18. These gaps 78 prevent the miter bar 30 from resting firmly against the first and second walls 46, 50 of the slot 18. Thus, when pressure is applied on a workpiece guided by the miter surface 34, the pressure is transferred through the miter housing 26 and into the miter bar 30, and the miter bar 30 is moved within the slot 18 until the main portion 70 contacts one of the first and second walls 46, 50 of the slot 18. This movement of the miter bar 30 prevents cuts from being precisely formed in the workpiece, because it prevents the position of the miter gauge 22, and thus the position of the workpiece, from being precisely controlled relative to the saw blade 12. As a result, the miter gauge 22 introduces undesirable angular variations in the cuts made by the table saw 10.

In view of the foregoing, it is apparent that there is a need for an adjustable miter gauge for table saws, which can prevent unwanted movement of the miter bar within the slot. There is also a need for an adjustable miter gauge for table saws, which can be adjusted to the dimensions of various slots. There is also a need for an adjustable miter gauge for table saws which enables easy adjustment of the width of the miter bar.

### SUMMARY

In one embodiment, a miter gauge includes a miter housing and a miter bar. The miter bar comprises a first portion to which the miter housing is attached and that has a fixed first width and a second portion having a width adjustment system configured to adjust a second width of the second portion. The second portion includes a first prong and a second prong separated longitudinally from one another by a longitudinal slot.

In another embodiment, a width adjustment system configured to adjust a width of a second portion of a miter bar includes a longitudinal slot defined in the second portion of the miter bar separating the miter bar into a first prong and a second prong, and a plurality of width adjusting arrangements spaced apart along a longitudinal direction of the second portion of the miter bar, each of the plurality of width adjusting arrangements configured to locally adjust a width of the longitudinal slot and thereby an associated width of the second portion.

In yet another embodiment, a miter gauge comprises a miter housing and a miter bar. The miter bar includes a first portion to which the miter housing is attached and that has a fixed first width, and a second portion having a width adjustment system configured to adjust a second width of the second portion. The second portion includes a first prong and a second prong separated longitudinally from one another by a longitudinal slot. Additionally, the width adjustment system includes a plurality of width adjusting arrangements spaced apart along a longitudinal direction of the second portion of the miter bar, and each of the width adjusting arrangements includes a first adjusting screw configured to exert a first force urging the first and second prongs away from one another, and a second adjusting screw configured to exert a second force urging the first and second prongs toward one another, the first and second forces acting together to locally adjust the width of the second portion.

### BRIEF DESCRIPTION OF THE DRAWINGS

FIG. 1 depicts a perspective view of a table saw including a conventional miter gauge.

FIG. 2 depicts a front partial view of a slot formed in the table top of the table saw shown in FIG. 1.

FIG. 3 depicts a front partial view of a conventional miter bar of the miter gauge of FIG. 1 received within the slot shown in FIG. 2.

FIG. 4 depicts a perspective view of a miter gauge according to the disclosure having a width adjustment system.

FIG. 5 depicts a perspective view of the miter bar of the miter gauge of FIG. 4.

FIG. 6 is a detail view of a portion of the miter bar of FIG. 5.

FIG. 7 is a top plan view of the miter gauge of FIG. 4 showing the forces produced on the miter bar by the width adjustment arrangements.

FIG. 8 depicts a perspective view of the miter bar of the miter gauge of FIG. 4 illustrating the adjustable and non-adjustable portions.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

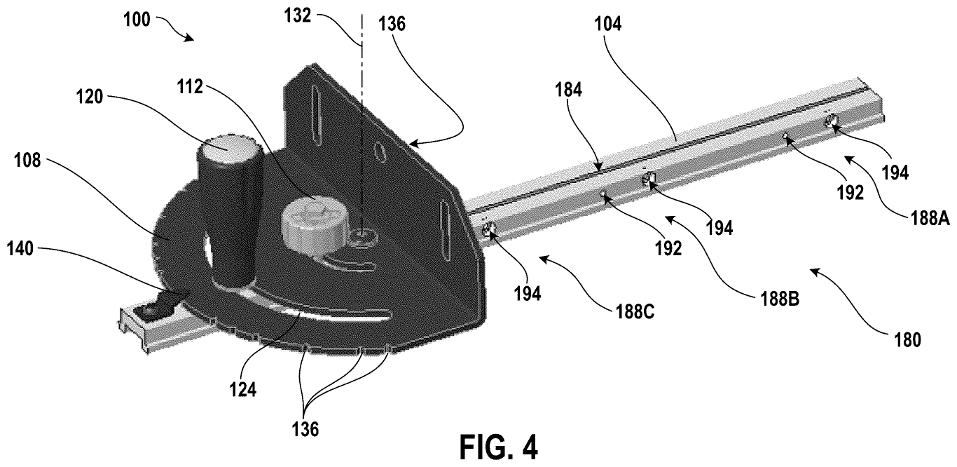

FIGS. 4-7 depict a miter gauge 100 according to the disclosure that is designed to reduce or eliminate the play between the miter gauge 100 and the slot 18, and thereby reduce or eliminate angular deviation and the resulting inaccuracies in the cut. The miter gauge 100 includes an elongated miter bar 104 and a miter housing 108, which is rotatably adjustably mounted to the miter bar 104. In particular, the miter gauge 108 includes a locking knob 112 that extends through an inner arcuate slot 114 defined through the miter housing 108 and is selectively engageable in a hole 116 defined in the top surface 118 of the miter bar 104 to clamp the miter housing 108 to the miter bar 104 so as to lock the rotational position of the miter housing 108 relative to the miter bar 104.

The miter gauge 100 has a handle 120 that extends through an outer arcuate slot 124 of the miter housing 108 and passes through or engages with a hole 128 in the miter bar 104. In addition, the underside of the miter housing 108 includes a pivot pin (not shown) that is pivotably positioned in a pivot hole 130. Together, the inner and outer arcuate slots 114, 124 and the pivot pin and pivot hole 130 define a pivot axis 132 around which the miter housing 108 pivots relative to the miter bar 104 when the locking knob 112 is disengaged to allow the angle of the miter surface 136 of the miter housing 108 to be adjusted.

The miter housing 108 also includes a plurality of detent notches 136 at commonly selected angles, for example at 0°, 15°, 22.5°, 30°, 45°, 60°, 67.5°, and 75° from perpendicular. A pointer 140, which is mounted to a hole 144 in the miter bar 104 near the proximal end 148 of the miter bar 104, identifies the selected angle on an angular scale (not shown) to aid the user in selecting the desired angle for the cross-cut using the miter gauge 100. In addition, the pointer 140 interfaces with the detent notches 136 to retain the miter housing 108 at the desired position while the user engages the locking knob to fix the miter housing 108 in place.

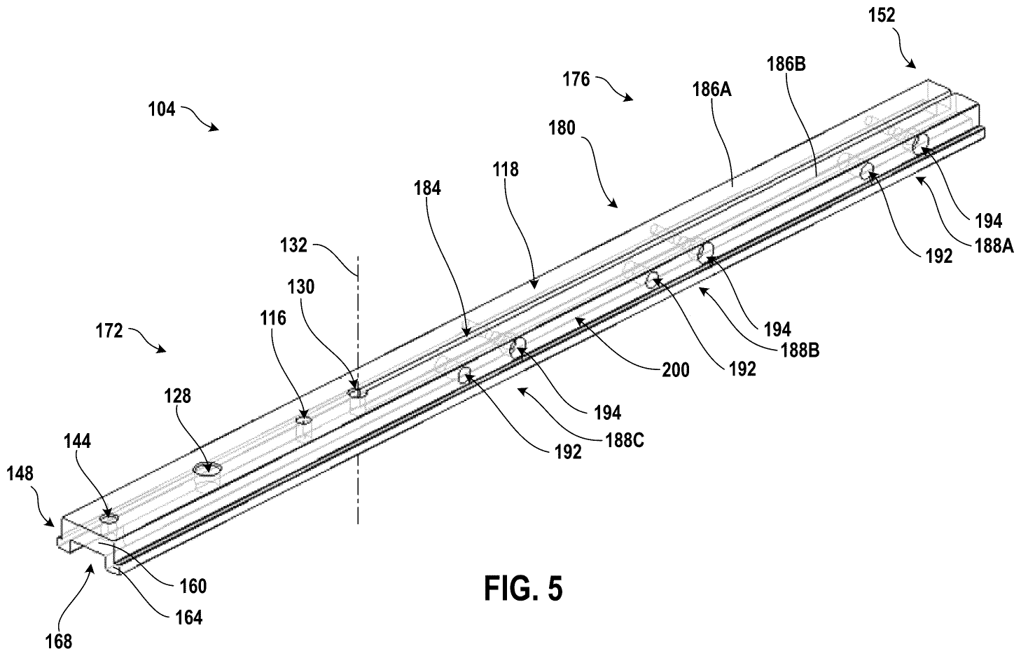

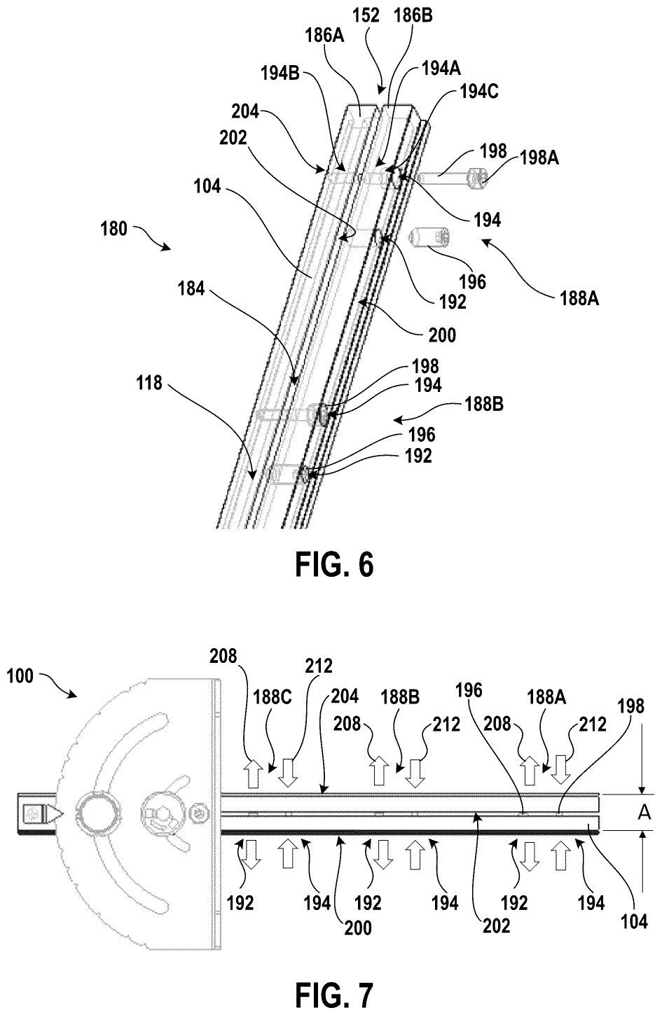

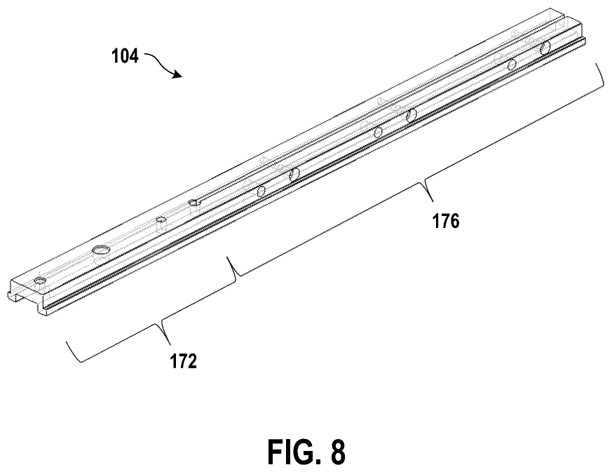

As best seen in FIGS. 5 and 6, the miter bar 104 has a main or upper portion 160 and an engagement or lower portion 164. The main portion 160 and engagement portion 164 define a generally T-shaped cross-section designed to fit within the slot 18 of the table saw 10. A lower recess 168 is defined through the engagement portion 164 and extending along the entire length of the miter bar 104 from the proximal, or first, end 148 to the distal, or second, end 152.

In addition, the miter bar 104 according to the disclosure includes a non-adjustable portion 172 on the side of the proximal end of the miter bar 104, and an adjustable portion 176 on the side of the distal end 152 of the miter bar 104. The adjustable portion 176 is adjustable via a precision width adjustment system 180 that is configured to adapt the width of the miter bar 104, and in particular the width of the main portion 160, to the width of the slot 18. The width adjustment system 108 includes a central longitudinal slot 184 defined through the main portion 160 of the adjustable portion 176 from the top surface 118 of the miter bar 104 to the recess 168 and extending from the pivot hole 130 to the distal end 152 of the miter bar 104. The longitudinal slot 184 separates the adjustable portion 176 into a first prong 186A and a second prong 186B that are spaced apart from one another substantially along the longitudinal center of the miter bar 104. The two prongs 186A, 186B therefore have widths that are approximately equal to each other. In various embodiments, the longitudinal slot may have a nominal width of between approximately ⅛ inch and approximately ¼ inch, though the reader should appreciate that larger or smaller longitudinal slots may be used in other embodiments.

In addition, the width adjustment system 180 includes a plurality of width adjusting arrangements 188A-C, three of which are shown in the illustrated embodiment. The reader should appreciate, however, that the number of width adjusting arrangements may vary depending on the length of the miter bar 104.

Each of the width adjusting arrangements 188A-C includes two holes 192, 194, and two adjusting members, which are configured as first and second screws 196, 198 in the illustrated embodiment. A first one of the holes 192 extends inwardly from the side surface 200 of the miter bar 104 to the longitudinal slot 184. The first hole 192 is threaded and is configured to receive the first screw 196, which is configured as a set screw, in such a way such that the first screw 196 is recessed in the first hole 192 and does not extend beyond the surface 200. When the first screw 196 is threaded into the first hole 192 far enough that the end of the first screw 196 engages the surface 202 of the first prong 186A, the first screw 196 exerts a force 208 (FIG. 7) that locally urges the two prongs 186A, 186B of the miter bar 104 away from one another, and thereby acts to increase the width of the longitudinal slot 184, and correspondingly the width A of the miter bar 104.

The second hole 194 has a first hole portion 194A extending through the second prong 186B of the miter bar 104 from the side surface 200 to the longitudinal slot 184, and a second hole portion 194B extending from the surface 202 in the longitudinal slot 184 at least partially into the first prong 186A. In the illustrated embodiment, the second hole portion 194B extends entirely through to the opposite side surface 204 of the first prong 186A. The first hole portion 194A is unthreaded and includes a countersunk or counterbored portion that has a shoulder 194C, while the second hole portion 194B is threaded. The second screw 198 is inserted into the second hole 194 such that the second screw 198 passes through the longitudinal slot 184 and engages the threaded second hole portion 194B, while the head 198A of the second screw 198 is fully recessed within the countersunk or counterbored portion such that the head 198A of the second screw 198 does not extend beyond the side surface 200. Further tightening of the second screw 198 causes the head 198A of the second screw 198 to engage the interior shoulder 194C of the first hole portion 194A, thereby exerting a compressive force 212 tending to pull the two prongs 186A, 186B toward one another so as to reduce the width of the longitudinal slot 184, and correspondingly the width A of the miter bar 104.

The first and second holes 192, 194 are spaced apart from one another in the longitudinal direction by a distance that allows for slight flexing of the two prongs 186A, 186B between the two holes 192, 194. In addition, the first and second holes 192, 194 of each of the width adjusting arrangements 188A-C are spaced apart from one another by a smaller distance than the distance between the respective width adjusting arrangements 188A-C, i.e. the distance between the first hole 192 of one width adjusting arrangement 188A and the second hole 194 of the adjacent width adjusting arrangement 188B.

To use the miter gauge 100, the user inserts the miter bar 104 into the slot 18 of the table saw 10. If, however, there is a gap (for example the gap 78) between miter bar 104 and the slot 18, the miter angle set by the relative angle between the miter housing 108 and the miter bar could be incorrect or inconsistent due to shifting of the miter bar 104 within the slot 18. Thus, the user removes the miter gauge 100 from the slot 18 in the table saw 10 to adjust the width of the miter bar 104 using the width adjustment system 180. Specifically, the user adjusts one or more of the width adjusting arrangements 188A-C by turning the screws 196, 198 of the associated width adjusting arrangement(s) 188A-C.

In particular, the width adjusting arrangements 188A-C are configured such that both screws 196, 198 of a given width adjusting arrangement 188A-C are adjusted together. For example, to increase the width A of the miter bar 104, the user screws the first screw 196 in such that the first screw 196 presses against the first prong 186A of the miter bar (represented by the force 208) and increases the width of the longitudinal slot 184 at the location of the first screw 196. The user also turns the corresponding second screw 196 in the opposite direction to reduce the compressing force 212 exerted by the screw head on the countersunk or counterbored portion of the first hole portion 194A of the second hole 194. The two screws 196, 198 may be, for example, adjusted by the same amount. In other words, both screws 196, 198 may be adjusted a quarter-turn at a time, or a half-turn at a time, etc.

The result of adjusting both screws 196, 198 is that the two prongs 194A, 194B elastically flex apart from one another at and adjacent to the adjusted width adjusting arrangement 188A-C. As a result, the width of the longitudinal slot 184, and therefore the width A of the miter bar 104, is locally increased at the location of the adjusted width adjusting arrangement 188A-C. The user may continue to adjust one or more of the remaining width adjusting arrangements 188A-C in the same manner, or the user may determine that adjustment of only one of the width adjusting arrangements is sufficient to eliminate the play of the miter bar 104 in the slot 18.

The user can then reinsert the miter gauge 100 in the slot 18. If the width A of the miter bar 104 is now sufficiently similar to the width of the slot 18, no more adjustment is needed. However, if the width A is still too small, the user can perform another adjustment to one or more of the width adjusting arrangements 188A-C. Conversely, if the width A is now too large for the slot 18, the user may perform the opposite adjustment to reduce the width A of the miter bar 104. This process may be performed iteratively until the user is satisfied that the play between the miter bar 104 and the slot has been reduced or eliminated and the miter bar 104 will not move within the slot 18 in such a way as to introduce angular errors in the crosscuts made.

As a result of the disclosed arrangement, the miter gauge 100 enables the table saw 10 to have high cross cuts accuracy due to the easily adjustable width adjusting system 100 that allows the width A of the miter bar 104 to be easily adjusted to the dimensions of the slot 18. The side gap 78, which causes angular inconsistency during cross cuts, can therefore be reduced or eliminated. In particular, the width adjusting arrangements 188A-C are adjustable from the same side of the miter bar 104, thereby facilitating easy adjustment. In addition, in some embodiments, the set screws 196 and the screws 198 are configured to be adjusted using the same size and type of driver bit, further facilitating easy adjustment of the screws 196, 198.

In the miter gauge 100, the three width adjusting arrangements 188A-C allow for the width of the miter bar 104 to be adjusted at multiple locations along the length of the miter bar 104. As a result, the miter bar 104 can be adjusted to have multiple contact points with the surface of the slot 18, thereby enabling the miter bar 104 to fit in the slot 18 with minimal or no play. Further, the width adjusting arrangement 188A nearest the distal end 152 of the miter bar 104 can be adjusted to be slightly smaller than the slot 18 to facilitate insertion of the miter bar 104 into the slot 18, while the two width adjusting arrangements 188B-C reduce or eliminate the play between the miter bar 104 and the slot 18.

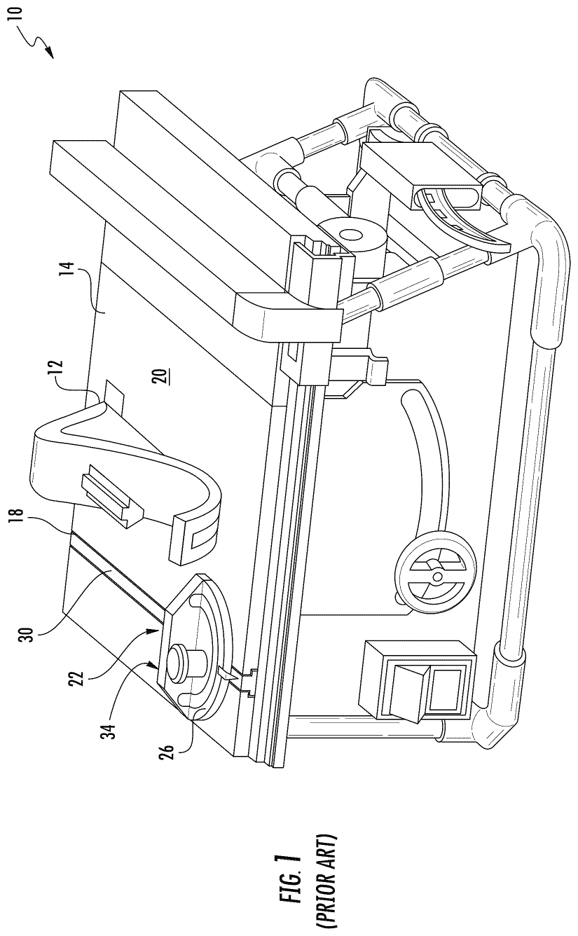

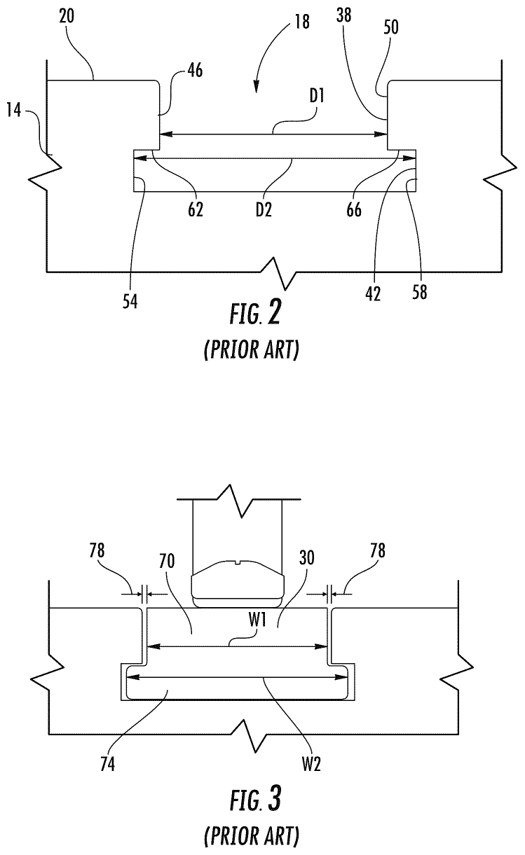

In addition, the disclosed width adjustment arrangement 180 is easy to manufacture and retrofit. In particular, the miter bar 104 can be formed with a relatively simple and economical extrusion process, with the longitudinal slot 184 and holes 192, 194 formed in the miter bar 104 either during the extrusion process and/or via a subsequent cutting or drilling process. Moreover, the width adjustment arrangement 180 can be added to a conventional miter gauge 22 with a relatively simple alteration. Specifically, the width adjustment arrangement 180 can be retrofitted onto existing miter gauges 22 simply by milling the longitudinal slot 184 in the conventional miter gauge (FIG. 1) and drilling and tapping the holes 192, 194.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

What is claimed is:

1. A miter gauge comprising:
a miter housing; and
a miter bar comprising:
a first portion to which the miter housing is attached and that has a fixed first width; and
a second portion having a width adjustment system configured to adjust a second width of the second portion, the second portion including a first prong and a second prong separated longitudinally from one another by a longitudinal slot.

2. The miter gauge according to claim 1, wherein the width adjustment system includes a plurality of width adjusting arrangements spaced apart along a longitudinal direction of the second portion of the miter bar, each of the plurality of width adjusting arrangements configured to locally adjust a width of the second portion.

3. The miter gauge according to claim 2, wherein each of the width adjusting arrangements includes a first adjusting member configured to exert a first force urging the first and second prongs away from one another, and a second adjusting member configured to exert a second force urging the first and second prongs toward one another, the first and second forces acting together to locally adjust the width of the second portion.

4. The miter gauge according to claim 3, wherein the first adjusting member is configured as a set screw, and the second prong includes a first threaded hole in which the first fastener is threaded, the first adjusting member being configured to exert the first force on the first prong so as to urge the first and second prongs away from one another.

5. The miter gauge according to claim 4, wherein:
the second adjusting member is configured as a screw,
the second prong defines a through hole having an interior shoulder,
the first prong defines a second threaded hole, and
the screw passes through the through hole and is threaded into the second threaded hole, the screw having a screw head configured to exert the second force on the interior shoulder urging the second prong toward the first prong.

6. The miter gauge according to claim 1, wherein the first prong defines a first outer surface of the miter bar, and the second prong defines a second opposite outer surface of the miter bar, said first and second outer surfaces configured to engage corresponding side surfaces of a T-shaped slot of a table saw.

7. The miter gauge according to claim 1, wherein the longitudinal slot extends substantially along a longitudinal center of the miter bar.

8. The miter gauge according to claim 7, wherein the miter bar defines a pivot hole separating the first portion from the second portion, the miter housing being selectively pivotable about the pivot hole.

9. The miter gauge according to claim 8, wherein the miter bar has a first end and a second end, the first portion including the first end and the second portion including the second end.

10. The miter gauge according to claim 9, wherein the longitudinal slot is defined in the miter bar extending from the pivot hole to the second end.

11. A width adjustment system configured to adjust a width of a second portion of a miter bar comprising:
a longitudinal slot defined in the second portion of the miter bar separating the miter bar into a first prong and a second prong;
a plurality of width adjusting arrangements spaced apart along a longitudinal direction of the second portion of the miter bar, each of the plurality of width adjusting arrangements configured to locally adjust a width of the longitudinal slot and thereby an associated width of the second portion.

12. The width adjustment system according to claim 11, wherein each of the width adjusting arrangements includes a first adjusting member configured to exert a first force urging the first and second prongs away from one another, and a second adjusting member configured to exert a second force urging the first and second prongs toward one another, the first and second forces acting together to locally adjust the width of the longitudinal slot.

13. The width adjustment system according to claim 12, wherein the first adjusting member is configured as a set screw, and each of the width adjusting arrangements includes a first threaded hole defined in the second prong and in which the set screw is threaded, the set screw being configured to exert the first force on the first prong so as to urge the first and second prongs away from one another.

14. The width adjustment system according to claim 13, wherein:
the second adjusting member is configured as a screw,
each of the width adjusting arrangement defines a through hole in the second prong, the through hole being defined by an interior shoulder,
the first prong defines a second threaded hole, and
the screw passes through the through hole and is threaded into the second threaded hole, the screw having a screw head configured to exert the second force on the interior shoulder urging the second prong toward the first prong.

15. The width adjustment system according to claim 11, wherein the longitudinal slot extends from a pivot hole, which separates the miter bar into a first portion having a fixed width and the second portion, to the second end.

16. A miter gauge comprising:
a miter housing; and
a miter bar comprising:
a first portion to which the miter housing is attached and that has a fixed first width; and
a second portion having a width adjustment system configured to adjust a second width of the second portion, the second portion including a first prong and a second prong separated longitudinally from one another by a longitudinal slot,
wherein the width adjustment system includes a plurality of width adjusting arrangements spaced apart along a longitudinal direction of the second portion of the miter bar, and
wherein each of the width adjusting arrangements includes a first adjusting screw configured to exert a first force urging the first and second prongs away from one another, and a second adjusting screw configured to exert a second force urging the first and second prongs toward one another, the first and second forces acting together to locally adjust the width of the second portion.

17. The miter gauge according to claim 16, wherein:
the first adjusting screw is configured as a set screw,
the second prong includes a first threaded hole in which the first fastener is threaded, the first adjusting member being configured to exert the first force on the first prong so as to urge the first and second prongs away from one another,
the second prong defines a through hole having an interior shoulder,
the first prong defines a second threaded hole, and
the second adjusting screw passes through the through hole and is threaded into the second threaded hole, the second adjusting screw having a screw head configured to exert the second force on the interior shoulder urging the second prong toward the first prong.

18. The miter gauge according to claim 17, wherein the longitudinal slot extends substantially along a longitudinal center of the miter bar.

19. The miter gauge according to claim 18, wherein the miter bar defines a pivot hole separating the first portion from the second portion, the miter housing being selectively pivotable about the pivot hole.

20. The miter gauge according to claim 19, wherein:
the miter bar has a first end and a second end, the first portion including the first end and the second portion including the second end, and
the longitudinal slot is defined in the miter bar extending from the pivot hole to the second end.
